(19) United States
(12) Patent Application Publication
(10) Pub. No.: US 2012/0010034 A1
(43) Pub. Date: Jan. 12, 2012

(54) TRACTION MECHANISM DRIVE HAVING A VIBRATION DAMPER

(75) Inventors: Jurgen Gilmer, Rauschenberg (DE); Thorsten Liebel, Furth (DE); Gerhard Prosch, Hochstadt (DE); Christoph Schuster, Weisendorf (DE); Johann Singer, Grossenseebach (DE); Christine Thomann, Bad Windsheim (DE)

(73) Assignee: SCHAEFFLER TECHNOLOGIES GMBH & CO. KG, Herzogenaurach (DE)

(21) Appl. No.: 13/257,635

(22) PCT Filed: Feb. 17, 2010
(86) PCT No.: PCT/EP2010/051991

§ 371 Date: Sep. 20, 2011

(30) Foreign Application Priority Data
Mar. 20, 2009 (DE) 10 2009 014 263.0

(51) Int. Cl. F16H 7/12

(52) U.S. Cl. 474/135; 474/133

(57) ABSTRACT

A traction mechanism drive, in particular for an internal combustion engine, including a vibration damper (1) having a base part (2) and a rotary part (3) that can be rotated to a limited extent relative to the base part against the effect of an energy store (6). Between the base part (2) and the rotary part (3), a friction unit (8) having a friction ring (9) formed of a support element (15) and a sliding element (16) arranged radially outside of the support element (15) for forming a friction contact in relation to a friction surface (10) is effective. The friction ring (9) is produced in one piece from the support element (15) and the sliding element (16), and the support element (15) and the sliding element (16) are cast on top of each other. A positive fit (17) is effective between said support element and sliding element in the circumferential direction.

### FIELD OF THE INVENTION

The invention relates to a traction mechanism drive, in particular, for an internal combustion engine, containing a vibration damper with a base part and a rotary part that can rotate to a limited extent relative to this base part against the effect of an energy storage device, wherein a friction mechanism with a friction ring is active between the base part and the rotary part.

### BACKGROUND OF THE INVENTION

Typical constructions of class-forming traction mechanism drives have a tensioning roller that is arranged so that it can pivot relative to the housing of the internal combustion engine and against the effect of an energy storage device; in this way, on one hand, vibrations brought into the traction mechanism drive by pivoting of the tensioning roller are damped and, on the other hand, the tension of the revolving element, for example, a belt, is held constant. For efficient damping of vibrations, it is further advantageous to superimpose a friction hysteresis that is set by a friction mechanism onto the energy storage device.

DE 2006 017 287 A1 discloses a traction mechanism drive with a vibration damper in which an energy storage device in the form of a coil spring is tensioned between a base part that is arranged stationary on the housing wall of the internal combustion engine driving the traction mechanism drive and a rotary part that is formed as a pivot arm and contains the tensioning roller. Here, a friction device is provided between the rotary part and an end of the coil spring, while, at its other end, the coil spring is supported directly on the base part. The friction device is formed by a friction ring that is produced in two parts from a support bushing and a friction lining. In addition to managing separate parts, the support bushing and friction lining must be fixed one on top of the other, so that additional processing steps are needed.

### SUMMARY

Therefore, the objective is given to provide a traction mechanism drive with a vibration damper that is easier and more economical to produce.

According to the invention, this objective is solved by a traction mechanism drive, in particular, for an internal combustion engine, containing a vibration damper with a base part and a rotary part that can rotate to a limited extent relative to this base part against the effect of an energy storage device, wherein a friction mechanism with a friction ring with a support element and a sliding element arranged outside of the support element in the radial direction is active between the base part and the rotary part for forming a friction contact relative to a friction surface. According to the invention, the friction ring is produced integrally from the support element and the sliding element, wherein the support element and sliding element are cast one on top of the other and a positive fit is active between these elements in the circumferential direction. Through this integral construction, the friction ring can be managed as a single part. The assembly is therefore simple.

A material-fit, integral production of the friction ring from components that can be combined with each other in a material fit is here avoided, because this would require a selection from only a limited number of materials. Instead, a positive-fit link between the support element and the sliding element is proposed, so that loading of the friction ring to be transferred only by the material fit can be eliminated. In this way, the selection of materials can be realized essentially freely, so that material pairings that are optimized to their application can be used. For example, the support element could be formed from metal, such as a lightweight metal, for example, aluminum and its alloys, or reinforced, wear-resistant plastics, while the sliding element could be produced from materials with high friction coefficients. In this way, there is only the requirement that one of the components can be processed by an injection-molding process. The second component could be extrusion-coated. In the case of two components that can be injection molded, these could be processed in a two-component injection-molding process.

The positive fit could be formed such that, in one of the two structural parts—the support element and/or the sliding element—a profiling is provided that is extruded with the component of the other structural part. In this way, the positive fit is provided at least in the rotational direction, for example, by a profiling in the circumferential direction. According to one advantageous embodiment, such profiling could be formed from ribs that are arranged parallel with respect to the rotational axis of the friction ring. Several of these ribs are here distributed across the periphery, for example, arranged on the outer periphery of the support element and are extrusion-coated with the component from plastic material, such as, for example, polyamide of the sliding element. In order to prevent, in particular, a premature detachment of the sliding element, the cross sections of the ribs could have a dovetail-shaped structure.

According to one advantageous embodiment, the rotary part is formed as a pivot arm with a tensioning roller held so that it can rotate on an axis arranged parallel to the rotational axis of the pivot arm and the base part is held stationary on a housing of the internal combustion engine.

The energy storage device could be formed from a coil spring supported on corresponding spring ends on the base part and the rotary part, respectively. Here, for direct tensioning of the energy storage device, such as a coil spring, between the rotary part and base part, the friction ring can be carried along directly by the rotary part, wherein a friction contact is produced between the base part and the friction ring. For rotation between the rotary part and base part due to vibrations introduced into the revolving element of the traction mechanism drive, a friction moment occurs between the friction ring and the base part that causes a damping of these vibrations through the resulting friction hysteresis in combination with the loading of the energy storage device. Here, for example, the pivoting movement of the rotary part carrying the tensioning roller is damped. For carrying along the rotation through the rotary part, the friction ring can make available corresponding entrainment devices, such as one or more cams directed inward in the radial direction.

Alternatively, the energy storage device could be supported on one end on the base part and on the other end on the friction ring, for example, by a cam directed inward in the radial direction with a corresponding stop surface for the energy storage device, for example, the spring end of a coil spring. Here, the friction ring is connected to the rotary part, in turn, locked in rotation in a corresponding way.

The setting of the friction ring could be performed advantageously as a function of the rotational angle between the rotary part and the base part. To this end, the energy storage device formed from a coil spring could be constructed in the radial direction in contact with the inner periphery of the support element, so that, for a rotation of the coil spring, when the rotary part and base part rotate relative to each other, the diameter of the coil spring increases as a function of the rotational angle and thus generates a normal force of the coil force outward in the radial direction on the support element and subsequently on the sliding element, wherein the friction moment between the sliding element and base part is increased. To this end, the friction ring is opened on one side. Advantageously, an elastic compensating link can hold the friction ring closed, so that the friction ring can be easily inserted into the inner periphery of the base part. The elastic compensating link allows an expansion of the friction ring past the assembly diameter as soon as the normal force of the coil spring loads this outward in the radial direction. As a function of the desired friction moment, the friction ring could also be installed in the base part already under biasing.

### BRIEF DESCRIPTION OF THE DRAWINGS

The invention will be explained in more detail with reference to the embodiments shown in FIGS. 1 and 2. Shown are:

FIG. 1 a cross-sectional view through a traction mechanism drive with a vibration damper with an integral friction ring and

FIG. 2 a view of an integral friction ring consisting of a support element and a sliding element.

### DETAILED DESCRIPTION OF THE PREFERRED EMBODIMENTS

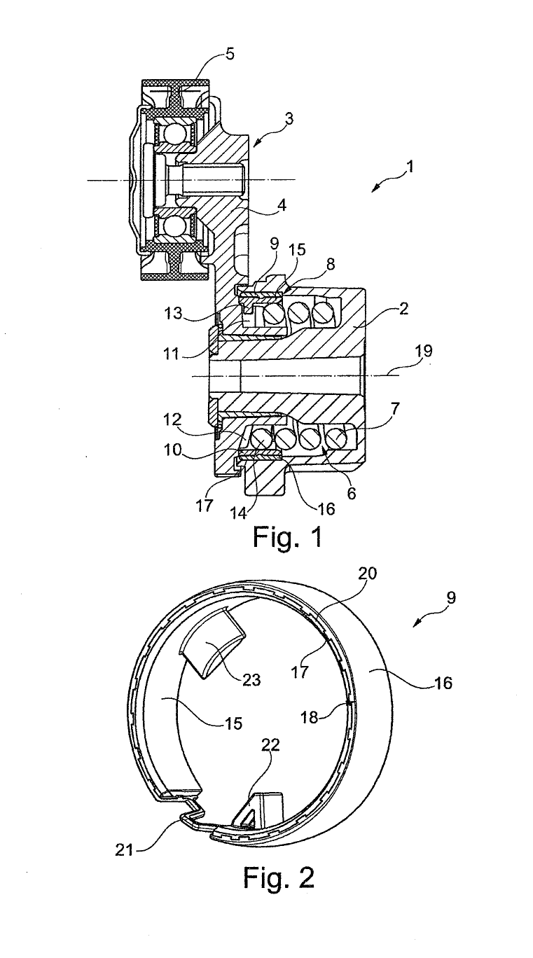

FIG. 1 shows a vibration damper 1 of a traction mechanism drive not shown in its entirety with a stationary base part 2 attached, for example, to a housing of the internal combustion engine and a rotary part 3 that can be displaced to a limited extent about the rotational axis 19 relative to this base part and is formed here as pivot arm 4 and has the tensioning roller 5 supported so that it can rotate relative to this arm. The tensioning roller 5 engages in the revolving element, for example, a belt, and sets its biasing and damps vibrations introduced into the traction mechanism drive through a pivoting of the pivot arm 4. A force compensating the tension of the revolving element is here applied between the base part 2 and the pivot arm 4 by an energy storage device 6 tensioned between these elements. This energy storage device is formed in the shown embodiment by a coil spring 7 that is tensioned by catch elements at one of its ends locked in rotation with the base part 2 and on its other end locked in rotation with the pivot arm 4, wherein, in FIG. 1, only the catch element 11 of the pivot arm formed in the axial direction of coil spring 7 is visible.

For damping vibrations that occur in the traction mechanism drive and load the vibration damper 1 by more or less rhythmic pivoting movements of the pivot arm 4, during a rotation, such as partial rotation or pivoting of the pivot arm 4 relative to the base part 2, a friction mechanism 8 is connected that is formed from the friction ring 9 and a complementarily formed friction surface 10 provided on the inner periphery of the base part 2. Here, in the case of relative rotation between pivot arm 4 and base part 2 by the pivot arm 4, the friction ring 9 is carried along by another catch element 12 that is provided on the pivot arm 4 and can also be formed in a simpler construction by the catch element 11 for the coil spring. This engages in the axial direction in the friction ring 9 and entrains this ring, locked in rotation, on a cam 13 extending inward in the radial direction. The friction ring 9 can be installed with biasing or with slight air clearance relative to the friction surface and obtains its biasing during a rotation of the pivot arm 4 relative to the base part 2 by an expansion of the coil spring 7 occurring in this way. Here, one or more windings 14 of the coil spring 7 act on the inner periphery of the friction ring 9 and determine, through the normal force of the coil spring 7 acting on the friction ring 9, the friction moment increasing with the rotational angle of the pivot arm 4 between the friction ring 9 and the friction surface 10, that is, between the pivot arm 4 and the base part 2.

Due to the special loads and requirements, the friction ring 9 is formed from two parts, the support element 15 and the sliding element 16 that are connected integrally to each other in the friction ring 9. The support element 15 is here produced from a material that can be loaded mechanically and in which neither the coil spring 7 nor the catch element 12 of the pivot arm can become buried. For example, the support element 15 could be made from aluminum by an extrusion method or from reinforced plastic. The sliding element 16 is designed according to the setting of an optimized friction coefficient with the friction surface 10 and is therefore formed from soft plastic, such as, for example, polyamide or another friction material that does not have to mechanically withstand the normal forces of the coil springs 7 due to the support by the support element 15.

The different requirements of the materials of sliding element 16 and support element 15 differ, in order to produce an integral friction ring 9 by an injection-molding method, for example, through a two-component injection-molding method with one component for the support element 15 and one component for the sliding element 16. A material fit between the two components has not proven to be sufficient throughout the service life. According to the inventive concept, for presenting a sufficient connection, in particular, in the peripheral direction, a positive fit 17 that is only indicated in the illustrated embodiment is provided between the two components of the support element 15 and sliding element 16.

FIG. 2 shows the friction ring 9 of FIG. 1 with the positive fit 17 changed slightly relative to this ring between the support element 15 and the sliding element 16. The support element 15 has, on its outer periphery, a profiling 18 that is formed in the shown embodiment from several ribs 20 that are distributed across the periphery and are oriented parallel to the rotational axis (FIG. 1) 19. The ribs 20 of the shown embodiment have a dovetail-like construction in cross section, but could also have other contours in other embodiments, for example, could be rounded. Furthermore, the profiling 18 could have other topographies.

To compensate for the diameter of the friction ring 9 changing due to the effect of the coil spring 7 (FIG. 1), the support element 15 is constructed as an open ring shape. The ring structure of the friction ring 9 is held together by a compensating link 21 that is formed from the material of the sliding element 16 and holds the friction ring 9 at least at the assembly diameter, so that this can be easily inserted onto the friction face 10 (FIG. 1).

The friction ring 9 has a cam 22 in the exemplary embodiment and is directed inward in the radial direction, by which the friction ring 9 can be loaded in the rotational direction. With reference to the vibration damper 1 of FIG. 1 and in modification to this damper, embodiments of several such cams that differ according to construction could be provided that are constructed as a function of the linking of the friction ring 9 in the flow of forces between pivot arm 4 and base part 2. Thus, for example, a cam for the rotational entrainment by the pivot arm 4 and a cam for the loading of the coil spring 7 could be provided. Alternatively—as shown—a cam 22 could be provided on which the catch element 11 of the pivot arm 4 connects and this is loaded in turn by the coil spring 7.

The friction ring 9 has at least one extension 23 that is directed inward in the radial direction and is used for the axial support of at least one winding 14, so that this remains fixed on the inner periphery of the support element and applies the normal force needed for forming the friction moment against the support element across the service life.

### LIST OF REFERENCE SYMBOLS

1 Vibration damper
2 Base part
3 Rotary part
4 Pivot arm
5 Tensioning roller
6 Energy storage device
7 Coil spring
8 Friction mechanism
9 Friction ring
10 Friction surface
11 Catch element
12 Catch element
13 Cam
14 Winding
15 Support element
16 Slide element
17 Positive fit
18 Profiling
19 Axis of rotation
20 Rib
21 Compensating link
22 Cam
23 Extension

1. Traction mechanism drive, for an internal combustion engine, comprising a vibration damper with a base part and a rotary part that can rotate to a limited extent relative to the base part against an effect of an energy storage device, a friction mechanism with a friction ring containing a support element and a sliding element arranged outside of the support element in a radial direction for forming a friction contact relative to a friction surface is active between the base part and the rotary part, the friction ring is produced integrally from the support element and the sliding element, the support element and sliding element are cast one on top of the other, and a positive fit is active between the support element and the sliding element in a circumferential direction.

2. The traction mechanism drive according to claim 1, wherein the rotary part forms a pivot arm with a tensioning roller supported so that the tensioning roller can rotate on an axis arranged parallel to an rotational axis of the pivot arm and the base part is adapted to be supported fixed in location on a housing of the internal combustion engine.

3. The traction mechanism drive according to claim 1, wherein the energy storage device is formed from a coil spring supported with corresponding spring ends on the base part and the rotary part, respectively.

4. The traction mechanism drive according to claim 1, wherein the energy storage device is formed from a coil spring supported with corresponding spring ends on the base part and the support element, respectively, with the support element being connected locked in rotation with the rotary part.

5. The traction mechanism drive according to claim 3, wherein the support element is loaded with a normal force by the coil spring that expands when the rotary part rotates relative to the base part.

6. The traction mechanism drive according to claim 3, wherein the friction ring is tensioned with biasing relative to the base part and is connected locked in rotation with the rotary part by at least one cam arranged inward in a radial direction.

7. The traction mechanism drive according to claim 1, wherein a profiling is provided on an outer periphery of the support element facing the sliding element.

8. The traction mechanism drive according to claim 7, wherein the profiling includes several ribs distributed across the periphery and oriented along a rotational axis of the friction ring.

9. The traction mechanism drive according to claim 8, wherein the ribs have a dovetail-shaped cross section.

10. The traction mechanism drive according to claim 1, wherein the support element is cast directly with the sliding element in an injection-molding process.

11. The traction mechanism drive according to claim 10, wherein the sliding element is injection molded onto the solid support element.

12. The traction mechanism drive according to claim 10, wherein the friction ring is produced in a two-component injection method with one component for the sliding element and additional components for the support element.

13. The traction mechanism drive according to claim 12, wherein the support element is produced from lightweight metal.

14. The traction mechanism drive according to claim 1, wherein the support element is made from plastic, advantageously reinforced plastic.
